(19) United States
(12) Patent Application Publication
(10) Pub. No.: US 2016/0217532 A1
(43) Pub. Date: Jul. 28, 2016

(54) Securing Claim Data via Block-Chains for a Peer to Peer Platform

(71) Applicant: Sure, Inc., San Diego, CA (US)

(72) Inventor: Wayne Slavin, San Francisco, CA (US)

(21) Appl. No.: 15/004,702

(22) Filed: Jan. 22, 2016

Related U.S. Application Data
(60) Provisional application No. 62/107,186, filed on Jan. 23, 2015.

(51) Int. Cl. G06Q 40/08; G06Q 30/02

(52) U.S. Cl. CPC G06Q 40/08; G06Q 30/0255; G06Q 30/0276; G06Q 2220/00

(57) ABSTRACT

Data is received characterizing claim information submitted for approval by a member of a peer-to-peer risk pool. The claim information is inserted as a transaction into a block using a private key. The block is added to a chain of blocks, the chain of blocks including prior claim and payment information of the member. The chain of blocks is distributed to a plurality of additional members of the peer-to-peer risk pool for review by the additional members for approving or disproving the claim. Related apparatus, systems, techniques, and articles are also described.

### RELATED APPLICATIONS

This application claims priority under 35 U.S.C. §119(e) to U.S. provisional patent application No. 62/107,186 filed Jan. 23, 2015, the entire contents of which is hereby expressly incorporated by reference herein.

### TECHNICAL FIELD

The subject matter described herein relates to securing claim data via a block-chain scheme and a custom computing platform that can tailor and deliver products based on contextual information.

### BACKGROUND

Insurance is the equitable transfer of the risk of a loss, from one entity to another in exchange for money. It is a form of risk management primarily used to hedge against the risk of a contingent, uncertain loss. An insurer, or insurance carrier, sells the insurance; the insured, or policyholder, buys the insurance policy. The premium is the amount of money charged for a certain amount of insurance coverage.

The transaction involves the insured assuming a guaranteed and known relatively small loss in the form of payment to the insurer in exchange for the insurer's promise to compensate (indemnity) the insured in the case of a financial (personal) loss. The insured receives a contract, called the insurance policy, which details the conditions and circumstances under which the insured is financially compensated.

Traditionally, before an insurance carrier will insure a potential client, insurance underwriters evaluate the risk and exposures of the potential client. They decide how much coverage the client should receive, how much they should pay for it, or whether even to accept the risk and insure them. Underwriting involves measuring risk exposure and determining the premium to charge to insure that risk. The underwriter protects the company's book of business from risks that may create a loss and issues insurance policies at a premium commensurate with the exposure presented by a risk. The underwriting process often takes several days or more to evaluate the level of risk posed by a potential client as well as to evaluate the insurance carrier's over-all risk exposure.

Often, insurance carriers offer a standard and static portfolio of insurance products.

In addition, traditional insurers do not typically bind insurance through online mediums. This is because customers with potentially bad risk (e.g., poor driving history, history of claims, and the like) may prefer to purchase insurance without talking to an agent. Agents serve as the first screening mechanism of an insurer's enrollment process by selecting clientele with a normal or preferred risk profile.

### SUMMARY

In an aspect, data is received characterizing claim information submitted for approval by a member of a peer-to-peer risk pool. The claim information is inserted as a transaction into a block using a private key. The block is added to a chain of blocks, the chain of blocks including prior claim and payment information of the member. The chain of blocks is distributed to a plurality of additional members of the peer-to-peer risk pool for review by the additional members for approving or disproving the claim.

One or more of the following features can be included in any feasible combination. For example, the claim information includes location of the claim, amount of loss defined by the claim, and cause of loss. The claim information can include name of the member who started the claim, the claim to payment ratio into the peer network of the member, and the member's claims history throughout time. Prior claim information can include historical claim information of the member submitting the claim. The payment information can include records describing a payment record of the member submitting the claim.

In another aspect, data characterizing real-time behavior and historical behavior of an individual can be accessed. A targeted insurance policy that includes a policy type and one or more policy terms is computed using the real-time behavior and the historical behavior. The policy type defining a type of loss the policy insures against. A targeted advertisement can be determined characterizing the policy type and one or more policy terms. When to modify an advertisement display space of a graphical user interface of a mobile device associated with the individual is determined. The determining is based on the real-time behavior and historical behavior of the individual. The advertisement display space is modified to include the targeted advertisement, the targeted advertisement prompting the individual to enter into the targeted insurance policy.

One or more of the following features can be included in any feasible combination. For example, the targeted advertisement includes a graphical object that, when selected by the individual, causes the individual to be bound to the targeted insurance policy. The advertisement display space can be a third party system and a selection of the graphical object in the targeted advertisement by the individual causes the individual to be bound to the targeted insurance policy via the third party system. The determining can be when to modify the advertisement display space includes computing a relevant time using a machine learning algorithm analyzing historical behavior data for the user and a plurality of additional users.

Computing the targeted insurance policy can include determining the policy type and one or more policy terms using a profile of the user characterizing risk associated with the user. Data characterizing real-time behavior can be received from the mobile device associated with the individual. The data characterizing real-time behavior can include one or more measurements from a sensor of the mobile device. The data can include one or more of accelerometer data, sound data, humidity data, and location data. Real-time behavior or historical behavior can be determined by performing a geo-fencing analysis of location data of the mobile device. Real-time behavior or historical behavior can be acquired by accessing an email account of the individual and parsing emails. Real-time behavior or historical behavior can be acquired by accessing a social network account or e-commerce account of the individual.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a system block diagram illustrating an example system that can tailor and deliver insurance products to an individual based on their real time behavior and historical behavior;

FIG. 2 is a data processing diagram illustrating an example process of the system that gathers an individual's behavior data, customizes insurance policies based on the behavior data, and provides targeted advertisements to the individual;

FIG. 3 is a system block diagram illustrating an example peer-to-peer (P2P) network that can implement a risk-pool; and

FIG. 4 is a process flow diagram illustrating a process of distributing claim information for approval to a plurality of users using a block-chain.

Like reference symbols in the various drawings indicate like elements.

### DETAILED DESCRIPTION

The current subject matter relates to a custom insurance computing platform that can tailor and deliver insurance products based on contextual information of the insured. Insurance in general is marketed through mass marketing (television, print, and the like) or direct marketing like telephone or mail. Insurers use demographics and list buying to better target their marketing messages. The custom insurance computing platform can customize insurance policies and enable direct marketing based on real-time behavior and analytics around each individual customer. The platform can collect data passively and/or actively that will allow the custom insurance computing platform to tailor insurance products to the individual and to market offers directly to the individual based on heuristics embedded in the platform. The platform can also provide two-way communication for insurance purchasing through chat applications or other channels.

In some implementations, the platform can implement a peer-to-peer insurance concept that provides consumers with the same level of protection as traditional insurance at a much lower cost. The platform can enable risk-pooling or crowdfunding in place of the pooled capital model used by traditional insurance companies. Members of the pool are profiled in real-time and when a claim is submitted for approval, the platform enables other members of the pool to vote to determine approval or denial. In order for the users to be fully informed for voting to approve or deny a claim, the platform can utilize a block chain to convey prior claim information and payment information for a user in a secure and trustworthy manner.

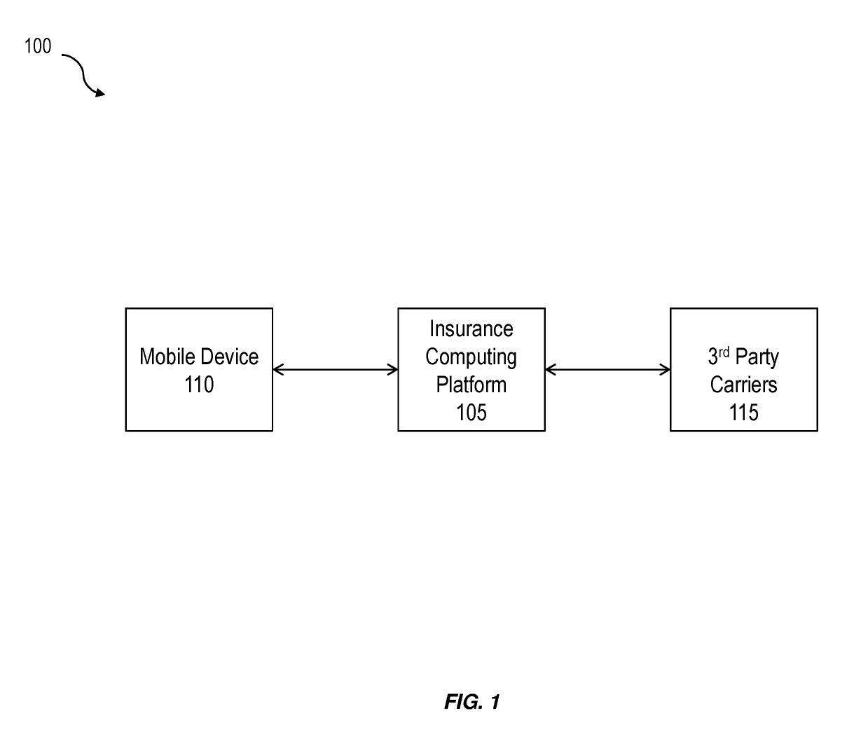

FIG. 1 is a system block diagram illustrating an example system 100 that can tailor and deliver insurance products to an individual based on their real time behavior and historical behavior. The system 100 includes an insurance computing platform 105 (also referred to as a server) in communication with a mobile device 110 and 3^{rd} party carriers 115 over a network. Behavior of a user of the mobile device 110 (e.g., cellular phone, tablet computer, and the like) can be monitored directly (e.g., via sensors of the mobile device 110) or indirectly (e.g., by accessing the user's accounts such as email, credit card, and social networks). The insurance computing platform 105 can customize insurance policies based on the user's behavior (e.g., accidental death insurance when the user arrives at an airport for an airplane flight or shortly after the user buys a plane ticket). Moreover, the insurance computing platform 105 can generate a targeted advertisement and determine a relevant time to push the advertisement to the user using the behavioral information. The behavioral information may be substantially real-time, historical, or both.

The user may also interact directly with the insurance computing platform 105 via the mobile device 110. The interaction may be via different mediums, such as SMS text messaging or web-browser. Software such as an application can be provided on the mobile device 110 and can display available options to the user (e.g., to register, seek an insurance quote, obtain insurance, submit an insurance claim, and the like), allow the user to input information (e.g., via text, by uploading photographs, and the like), and may bi-directionally communicate with one or more servers of the insurance computing platform 105 in order to offer and consummate insurance protection for the user. The software may also allow for monitoring of characteristics of the mobile device 110 that characterize the user's behavior, such as outputs from its GPS sensor, humidity sensor, microphone, and the like.

The insurance computing platform 105 can receive and respond to requests from mobile devices 110, determine pricing, and/or other terms for insurance, process insurance claims, track user behavior data, and the like. User behavior data that is recently received (e.g., within a predefined period) can be considered as substantially real time behavior data. User behavior data that was not recently received (e.g., not within a predefined period) can be considered as historical user behavior data.

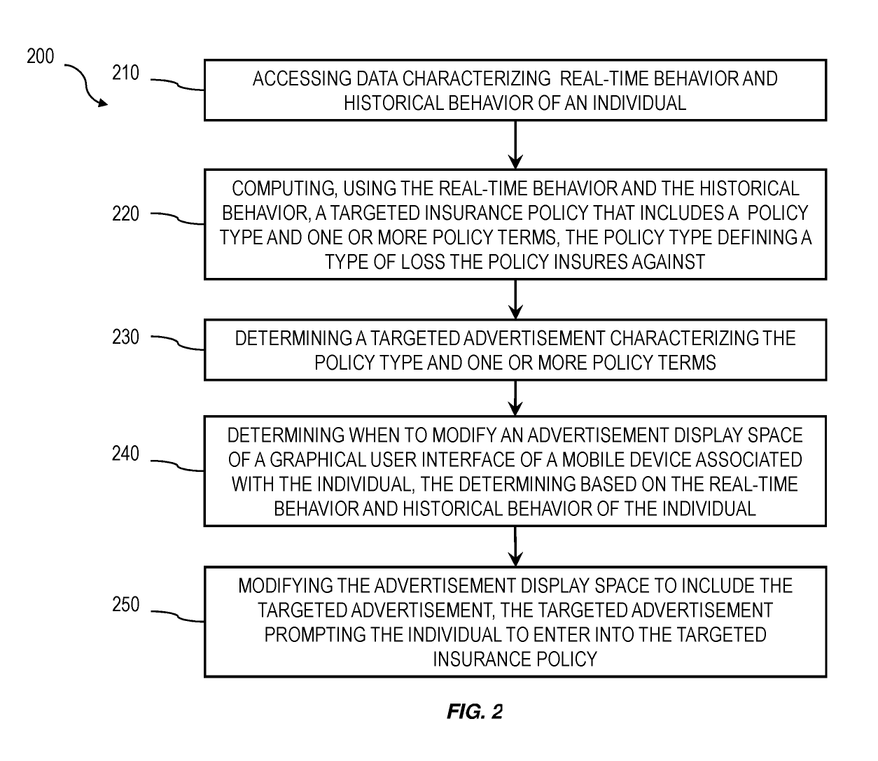

FIG. 2 is a data processing diagram illustrating an example process 200 of the system 100 that gathers an individual's behavior data, customizes insurance policies based on the behavior data, and provides targeted advertisements to the individual. At 210, platform 105 can access and/or receive real-time behavior and historical behavior data for an individual. The platform 105 can received the real-time behavior from the mobile device 110. The behavior data can be from sensors of the mobile device 110 such as accelerometer data, sound data, humidity data, and location data. The behavior data can be parsed from accounts such as email, credit cards, and social networks. In an implementation, the user provides credentials to platform 105 to enable platform 105 to access the user's email, credit cards, and social networks. Platform 105 can parse these accounts to acquire the behavior data. For example, the platform 105 can access a user's email account and monitor received emails to determine whether the email includes a receipt for a recently bought product.

At 220, platform 105 can compute a targeted insurance policy using the real-time behavior and the historical behavior. The targeted insurance policy can include a policy type and one or more policy terms. The policy type can define the type of loss the policy insures against, such as accidental death, property (homeowners, rental, auto, and/or personal), and episodic activity based insurance. The policy terms can include cost, which can be based on an assessment of underlying risk. Additional terms can include length of policy, scope of coverage, exclusions, and the like. Computing the targeted insurance policy can include computing or determining the policy type and policy terms. The determinations may be based on an underwriting profile including the received historical and real time behavior data. The underwriting profile can describe characteristics of the user including a risk assessment. A custom policy may also include information learned from data sources such as what type of auto they drive, or usage of a ride sharing service (e.g., Uber), and provide the user a comprehensive policy covering their exact auto, their exact model of cellphone, their home address using GPS data with the proper policy limits based on the size of the house automatically collected from public data sources and private sources like Zillow to ensure a truly customized policy for the user.

For example, over time the platform 105 can use the behavior data to determine that a user lives in a safe neighborhood (based on the phone's geolocation at night) and commutes by auto to work over a very short distance (based on the phone's geolocation during the day). When compared to other users of the system 100, a particular user may present a preferred type of underwriting risk and the platform 105 may compute a targeted insurance policy to offer this user discounted, customized, or bundled policies that suit the user's behavior and lifestyle. For example, the policy types can include Homeowners/Renters policies or for Personal Auto Policies. In addition, location based behavior data may be used to determine if the platform has insurance product types that are available in their region (e.g., state and country) that would be suitable for the consumer based on their behavior.

By profiling the behavior data the platform 105 collects, the platform 105 may decide that certain users should not be offered specific products or be charged a higher premium given their behavior. For example, if a user's smartphone reports frequent fast accelerations (drops), the platform 105 may use that data collected over time (e.g., historical behavior data) when underwriting the device insurance at some point in the future.

The platform 105 may also use the user's behavior and purchase history to determine what is an acceptable Life Time Value (LTV) of the user and make an underwriting decision as part of computing the targeted insurance policy terms. For example, if the platform 105 determines that users who purchase Smartphone, Pet, and Homeowner's Insurance are two times more likely to purchase Flight Insurance. The system 100 may determine that offering a user an additional product at better than market rates to create an engaged customer improves the LTV. The platform 105 may offer Smartphone Insurance to a user at a subsidized rate or for a sub-standard risk type user in order to create better engagement over the lifetime of the user.

In some implementations, computing a targeted insurance policy can be implemented by a foundation of rules/heuristics that will power a machine learning algorithm to automatically make underwriting decisions in real time.

Platform 105 may be able to detect from the behavior of the consumer to determine their Home address. This can be achieved by collecting location data from the mobile device to determine when the device is at rest and not moving for extended periods (e.g., while the customer is asleep). Using several days of data, the platform 105 is able to automatically identify the coordinates of the customer's home and selectively offer homeowners or renters insurance to the customer.

At 230, system 100 can determine a targeted advertisement. The targeted advertisement can characterize the policy type and one or more policy terms. The system 100 can tailor both the targeted advertisement sent to the user as well as the insurance policy. For example if a user is flying from Los Angeles airport (LAX) to John F. Kennedy airport (JFK) on Delta, the targeted advertisement received may include details of the airports, the airline, and flight number. Additionally it may include weather data to include the forecast in the targeted advertisement to drive sales. The policy itself may be customized to cover only the single flight and the amount of insurance the user has purchased previously as their preferred amount. The system 100 can save a step by simply offering what it knows from historical data the user wants to purchase. Additionally, the system 100 can mention the exact item a user purchased from an ecommerce store (e.g., Apple store, Amazon, and the like) when offering insurance. The policy may be customized based on public or historical data about the article being insured. For example, a low-end television that breaks often may receive a higher deductible from the system 100 than one that's known to be reliable for 72 months.

At 240, system 100 can determine when to modify an advertisement display space of the mobile device 110. The determination can be based on the real-time behavior and historical behavior of the individual. Platform 105 allows for notifications to be delivered to specific cohorts of users, potentially within specific geographic areas, or with certain social behaviors. The platform 105 can target down to a single specific user to allow for focused marketing.

The platform 105 determines an optimal period to push the targeted advertisement to the user by determining a period when the contextual relevancy of the insurance policy is high. This determination may be based on a variety of behavior data including location, email data, and beacons in retail stores.

For example, if a user has entered a Pet Store one or more times in a specific period defined by the platform 105 (e.g., monitored on an ongoing basis) the customer may be automatically segmented into a cohort as a potential ‘pet-owner’. The platform 105 can therefore automatically send an offer of pet insurance directly to the customers. This allows for the platform 105 to specifically target customers with the right type of insurance at the right time to drive high conversion rates.

As another example, the platform 105 may offer customers the ability to purchase Flight Accident insurance. Once the customer arrives at an airport (this event can be deduced from the received behavior data) the platform 105 will trigger a specific notification (SMS, Push, Email, Phone call, and the like) at the determined time. Further, this can be exemplified by a 23-minute or dynamic delay from arrival at the airport until the customer arrives at their departure gate. The customers at the departure gate have a higher rate of purchase and therefore the notification system is more effective by having customized delivery timing for each type of notification.

The platform 105 can leverage the location/GPS data provided by the user's mobile device 110 to automatically detect when a customer arrives at a location that has contextual value and relationships to the types of insurance being offered through the platform 105. Further, the platform 105 can utilize geofencing of areas on maps (Google, Bing, Yahoo, and the like) by outlining a polygon shape as a boundary that is added to the system as a virtual boundary/trigger for a notification alert if a mobile device 110 were to enter the polygon. For example, the platform 105 may offer accident insurance for Skiers and Snowboarders. The platform 105 may contain preconfigured notifications tied to polygons around specific or all ski resorts/lifts. Once a customer's mobile device 110 enters into the areas bounded by the polygon on the mapping system the customer can receive a notification for accident insurance tailored to their upcoming skiing or snowboarding activities. The insurance offered can relate to the skiing/snowboarding activities and possibly only available while the customer is within the boundaries of the polygon. Further, the defined area may be as small as a single retail store within a shopping mall.

The platform 105 can also detect when a customer enters into a specific retailer by detecting beacons within the physical location. These beacons can trigger notifications in the system automatically. For example, if a customer enters a specific store, the mobile device 110 can automatically push an offer of product warranty/insurance to the customer at the time they are checking out of the store. This effect can also be achieved using the geofencing system in the platform 105.

At 250, the system 100 can modify the advertisement display space to include the targeted advertisement and at the determined time. The targeted advertisement can prompt the individual to enter into the targeted insurance policy. In an implementation, the targeted advertisement can include a graphical object that when selected by the user, causes the user to be bound to the targeted insurance policy. The advertisement display space can reside within a third party system (such as a messaging application or medium) and a selection of the graphical object in the targeted advertisement by the individual causes the individual to be bound to the targeted insurance policy via the third party system.

In some implementations, the system 100 can leverage a two-way notification system to offer insurance to the customer and by receiving a response in real time through a 3rd party system (e.g., Facebook Messenger, Whatsapp, SMS, and the like) to automatically enroll the customer in the insurance offered through the notification platform. The two-way purchase process may initiate through a generic or targeted push notification. Once the customer replies to the message, it becomes a two-way process.

For example, an example system that delivers a 1-way notification sends a Push Notification, Email, and/or In-Application message to the consumers who then must take proactive steps to open the appropriate application to make a purchase. With a two-way notification system platform 105 can directly communicate with the customer via a 3rd party system (e.g., Facebook Messenger, Whatsapp, SMS, and the like) to directly offer them an insurance product. The user can simply respond to the message with a ‘Yes’/‘No’ or other live chat communication to actually bind and purchase the insurance to their existing account (e.g., an account associated with the insurance computing platform 105).

For example, if platform 105 detects that a customer has just purchased a new television from an e-commerce site (e.g., Amazon) and provided the platform 105 with a mobile phone number or access to a messaging account name (e.g., Facebook Messenger Account, Whatsapp account, and the like), the platform 105 can message them directly through one or more of the mediums to ask a question similar to: “Hello Carter, we see you've purchased a new TV from Amazon.com. Would you like to insure it for $1.27/month? Reply Y/N to automatically enroll and purchase protection for your new television.”

The system can parse the customer's response “Y/N” automatically. In addition, customers may purchase insurance from platform 105 without using a dedicated application for interacting with the platform 105. A chat session on a medium (e.g., SMS, Whatsapp, Facebook Messenger, and the like) can consummate the entire transaction.

Platform 105 may allow customers to automatically link their existing e-commerce profiles (such as Amazon, Alibaba, AirBNB, Uber, Lyft, and the like) to an account associated with the platform 105. The platform 105 can monitor, at regular intervals, the customer's profile on any or all third party e-commerce platforms to detect if the customer has made any new purchases. These new purchases or other platform activities may trigger new notifications for types of insurance that are relevant to the customer. Additionally, platform 105 may use these activities as data points (e.g., historical behavior data) that factor into the underwriting profile for a customer on the platform 105.

For example, if the platform 105 detects the user makes a new purchase to book an AirBNB, then the platform can offer the customer a type of insurance tailored to staying in an AirBNB.

Platform 105 can connect to a customer's bank or payment account (a third party platform like Yodlee may be used). The platform 105 can automatically parse transactions in the customer's account to determine if any purchases/vendors correlate with types of insurance products offered through the platform 105. These purchases can trigger automatic notifications to the customer through various mediums. For example, if the platform 105 detects a purchase at an Apple Store on a Chase Visa Debit card account. The platform 105 can push a notification to the customer to offer them insurance on their new Apple purchase.

Vendors can be automatically coded for the types of products and/or services sold at each merchant and the platform 105 can leverage this data to better target and categories the insurance notification offers. For example, platform 105 can automatically notify and offer a customer plane flight insurance when the platform 105 detects that they have purchased an airline ticket from American Airlines on their Discover Card.

The platform 105 enables the customer to connect their email address account (Gmail, Yahoo, Microsoft, and the like) to an account associated with the platform 105. Once connected, the platform 105 will automatically parse their email (inbox and saved messages) as well as future emails and existing emails. The platform 105 can automatically parse emails searching for specific email senders, subjects, and message bodies that relate to types of insurance offered through the platform. For example, if a customer purchases a new television from an e-commerce site, the customer receives an email receipt including the shipping details, price paid, model number, and the like. This information, when parsed by the platform 105, can trigger an automatic notification to offer the customer a warranty and/or insurance protection plan tailored to their new purchase. Platform 105 can tailor these notifications specifically to each product such that the customer receives an actual pricing offer of the insurance in the notification and not simply a generic notification. For example, in the above use case the customer may receive a notification asking if they would like to protect their new TV purchase for $1.27 per month rather than just a generic offer alerting them to the availability of insurance. This is possible because the platform 105, through parsing email receipts, knows that the customer purchased a TV, and specifically knows the model purchased. Using this information, underwriting costs can be calculated in real time and factoring in elements including the customer's shipping address, method of payment, and historic purchasing and/or returns behavior. Parsing of their email account can extract more data to create a more complete underwriting profile for each customer.

Further, the shipping address from the email receipt can become the default insured's address and domicile for underwriting the new insurance policy.

As another example, the platform 105 can automatically parse flight purchases through email receipts and pre-configure notifications to deliver to the customers at the appropriate time before their scheduled departure. The system can automatically parse the flight information from the receipt and set up the notification to deliver in the future through the platform 105.

Platform for Peer-to-Peer (P2P) Risk-Pooling

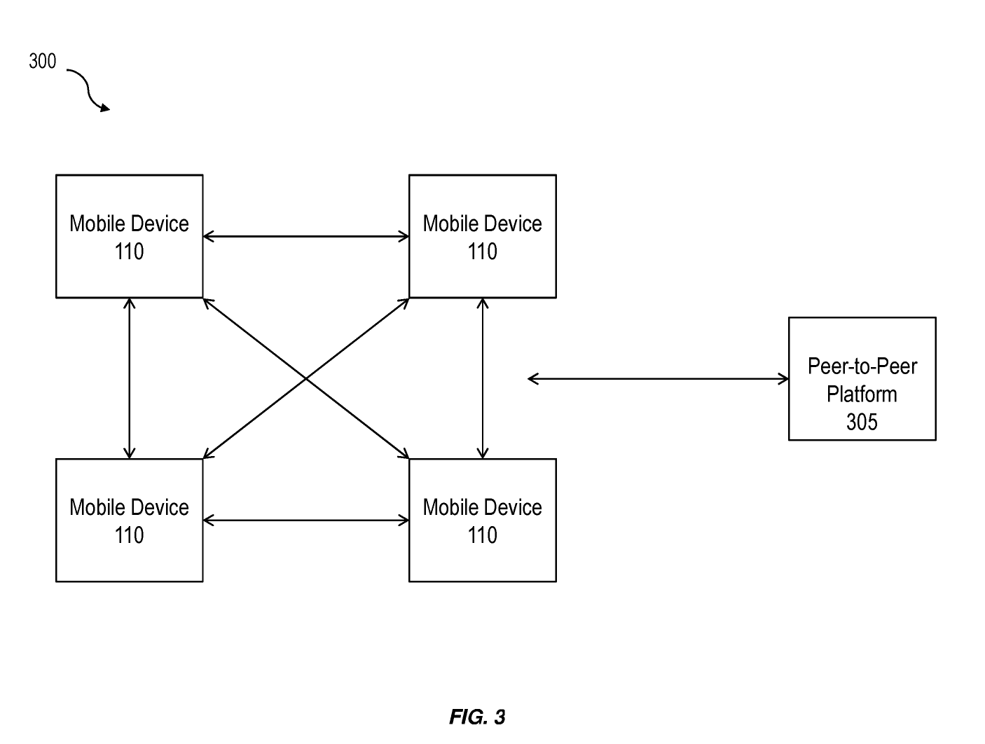

FIG. 3 is a system block diagram illustrating an example peer-to-peer (P2P) system 300 that can implement a risk-pool. The membership group of peers belonging to the risk pool can be referred to as a peer network. System 300 includes peer-to-peer platform 305 (also referred to as a server) in communication with multiple mobile devices 110 over a communications network. The mobile devices 110 are in communication with one another. Platform 305 may make use of a centralized or distributed block chain (e.g., database or ledger) to contain information about each claim initiated on the system 300 in a risk pool. This means that because Members/Peers (e.g., the network) are liable for payments on claims that they should, if they so desire, be able to see details about each claim initiated, approved, declined, and paid in the system.

A risk-pool insurance approach turns the notion of monthly insurance premiums on its head. Members only make payments based on the total claim reimbursements made each month to all members of the network. For example, when a new customer enrolls in Homeowner's Insurance coverage from the risk pool they join the other 100,000 members already covered as part of the pool. Joining a pool has no premium associated with it and members receive coverage protection instantly. No underwriter or broker is need. Members may be charged a monthly membership fee per line of insurance. This charge is not for a payment toward their policy premium. It serves two function; first, to support the operations of the entire platform for all member and second, to validate that the member has a valid payment method activated to reduce payment problems when premium collection is due monthly.

On a monthly basis, members of the pool pay their 1/Nth of their share of the claims paid out by the pool. This means that if in a given month $5,000,000 of claims were paid out from pool then each of the 100,000 members would only pay $50—a fraction of their previous monthly premium. This amount is calculated automatically by the platform and may be based on the total number of members in the pool or based on the member's Quota Share (QS) of the entire value of the pool based on the asset value of their insured property. This is a reciprocal type of coverage where each member agrees to pay their share of the claims paid out by the platform 305 on behalf of the other members of the pool. Members looking to limit their monthly payment can easily select a maximum amount they wish to pay and receive the coverage benefits appropriate to that level of membership. The payments that are paid out will be in proportion of their individual risk as a percentage of total risk known as their participation quota (e.g., Quota Share).

Using platform 305, consumers can receive insurance coverage as a guaranteed benefit from joining a community that helps everyone save money on insurance. Risk pools also deliver a new level of transparency and community participation in contrast to the world of big insurance providers. Consumers will no longer pay premiums up front and let the insurance company keep their money when it is not being used to help anyone. Risk pools allow for insurance without the costly company.

But in risk pools Members/Peers (e.g., the network) are liable for payments on claims. In some risk pools, the members are responsible for approving or disproving claims. As a result, they should be able to see details about each claim initiated, approved, declined, and paid in the system. Because modification of the historical claim information by users would distort perceived risk or fraudulent activity, a block chain may be used. A block chain (e.g., database or ledger) to contain present and historical information about each claim initiated on the system 300 in a risk pool is a means for maintaining and distributing that information in a manner that ensures the information is reliable to the membership (e.g., the peer network).

Information about each claim that may be desired to be included in the block chain may include both general information about the claim, location, amount of loss, cause of loss, and the like; and personal information about the claim like the name of the Member/Peer who started the claim, their claim to payment ratio into the peer network, and their claims history throughout time. By making use of the block chain Members can see transparently who are the abusers and fraudulent users of the network 300 and decline to provide coverage for these members in the future.

A block chain can include a permissionless distributed database that maintains a continuously growing list of transactional data records with protections against tampering and revision, even by operators of the data store's nodes. A block chain implementation includes transaction records and block records. Transactions are the actual claim information data to be stored in the block chain and block record. The blocks confirm when and in what sequence transactions became journaled as a part of the block chain database. Transactions are created by the platform 305 when a user submits a claim for approval. Blocks are also created by the platform 305. The block chain is primarily tamper resistant through timestamping the hash of batches of recent valid transactions into “blocks”, proving that the data must have existed at the time. Each block includes the prior timestamp, forming a chain of blocks, with each additional timestamp reinforcing the ones before it. Each block chain record is enforced cryptographically by the platform 305 signing the block with a private key.

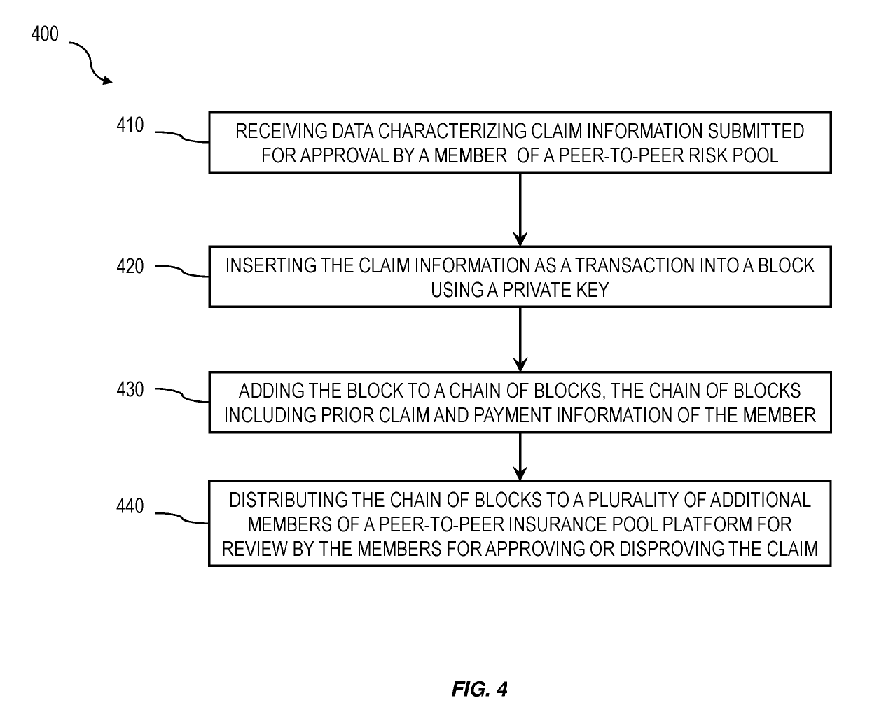

FIG. 4 is a process flow diagram illustrating a process of distributing claim information for approval to a plurality of users using a block-chain. At 410, data is received characterizing claim information. The claim information can include general information about the claim, location, amount of loss, cause of loss, and the like; and personal information about the claim like the name of the Member/Peer who started the claim, their claim to payment ratio into the peer network, and their claims history throughout time. At 420, the claim information may be inserted as a transaction in a block using a private key. At 430, the block can be added to a chain of blocks including prior claim and payment information. The prior claim information can include historical claim information of the individual submitting the claim. The payment information can include records describing the payment record of the individual submitting the claim (e.g., when and how great their monthly payments are). At 440, the chain blocks (e.g., the block chain) can be distributed to a plurality of users of the peer-to-peer insurance pool platform for review by the users for approving or disproving the claim by the users.

An advantage of a risk pool is that the ultimate deployment of premiums in a risk pool is for directly settling claims. This is achieved with efficiency because there is no hemorrhage of brokerage commissions and expensive administration fees as with traditional insurance distribution. This new methodology can enhance the consumer economics by at least 30% over traditional insurance.

Binding insurance online can pose a problem of selecting only ‘bad risk’. In some implementations, platform 305 can compensate for adverse selection to binding online. The platform 305 can use technology to validate consumers throughout their lifetime in the risk-pool to ensure that there is no adverse selection problem.

The platform 305 performs upfront validation by requiring a customer to create a profile in the system. However, given the financial nature of insurance and the possible fraud concerns, platform 305 takes additional measures to validate the identity of customers prior to allowing them to transact on the platform. For example, as an initial validation the platform 305 confirms the customer's email address, their telephone number, and social media accounts. To enroll property into the peer network members may be required by the platform to provide validation of insurable interest in the property.

For example, the user may be asked to provide, via a picture uploaded, a copy of identification. This identification may be required to match the address of the insured property. Alternatively or additionally, the member may need to provide proof of residency from alternate sources like utility or other bills. The member may also be required to authenticate a bank account that matches the name provided on their identification.

Validation is on-going. The platform 305 may make use of data collected from an application on an insured's mobile device 110 to determine if a claim in the past could have been fraudulent. Similarly, data from the user's behavior within the network (payment, voting, claims, and the like) will also factor into the decisions by the network (algorithmic or human) to keep the user in the system or to remove them as a bad actor. The platform 305 may choose to validate data about a user including their driver's license, home address, social security, and bank account before letting them insure items, items over a certain value, or make a claim to the network.

The platform 305 operates as network moderator. Platform 305 can control the quality and risk of the network by providing the pool and peers additional checks to detect fraud and other bad risks. This control may be implemented through algorithms or humans moderating. Alternatively, platform 305 may turn over control mechanism to the peer network to decide what risk is allowed to be insured and to detect fraud, approve or deny claims, and collect premiums due. In the case that other members of the network are moderating all administration, the platform 305 may provide insights and data that would not be accessible or parsable by a single person.

Platform 305 may allow any user to join the network or a given risk pool and can conduct automatic validations to prove the user is not fraudulent. For example, the platform 305 may ask new users to conduct a series of tasks, like validate other claims known to be fraudulent, as part of their onboarding. This will give the platform 305 an idea if the user is trustworthy or not. The platform 305 may have a waiting period before a user who has joined the risk pool and paid premiums can make a claim to prevent users with an existing loss from joining for free/nominal fee from making a claim and leaving the network. The platform 305 may use the age, number of connections, activity history, and other aspects of a user's social media profile to determine the risk related to a user. For example, if a profile is 3 days old it carries far less value than a 12 year old profile on Facebook with 2000+ connections.

In a risk pool, commitments are made by members. The risk pool does not function if members make a claim and then do not maintain an active status to pay other claims in the network. As such members may be required to extend their membership by 12 months after a claim is made by them. Similar to receiving a subsidized smartphone from a cellular network provider. By receiving a subsidized smartphone a member must commit to maintaining their cellular network membership for an additional period of time. If the member would like to leave the risk pool early they will be required to pay a termination fee in proportion to the claim previously made by them.

The platform 305 can provide for multiple risk pools. The platform 305 may decide that each line of insurance (homeowner's, auto, and the like) exists as an individual pool. Meaning that each pool requires its own significantly large number of members, each member is rated by their peers, and the mechanics of one pool may or may not replicate other pools. Additionally, each pool/separate line of insurance may calculate an individual's Quota Share based on the utilization and size of each pool. Alternatively, the platform 305 may include all members into one financial pool for all lines of insurance and calculate each individual's total Quota Share across all lines of insurance and charge them accordingly.

The platform 305 charges each member an equitable monthly premium. Members of the network may wish to insure a wide range of property. For example, a member may want to insure a person auto valued at $8,000.00 and another member may want to insure a personal auto worth $80,000.00. The platform 305 may create tiers within the network to keep risk pools in price bands. For example; $1-5k, $5-10k, $10-$15k, etc. If a tier, like $150k+ does not have enough members to make the risk pool viable the platform 305 may place a wait list on the insurance until enough members have been identified. Alternatively, platform 305 may simply calculate all risk based on dollar value. For example, if one member's car is valued at $8,000.00 and another's at $80,000.00 then the owner of the less expensive auto simply pays 1/10th of the premiums per month based on the claims paid by the entire network.

This creates a system where the smaller the risk the smaller the obligation, and the larger the risk the larger the obligation to pay into the network. This allows the network to aggregate (e.g., pool) across different types of insurance risks. For example, a renter's insurance policy may only have $50,000.00 worth of personal property coverage while a mansion has over $500,000.00 of personal property risk. All of these values are factored into a particular member's Quota Share of the network. For example, a member with a $20,000.00 auto and $80,000.00 personal property policy would have a total value of $100,000.00 to the network. If the network were to have a total insured value of $1,000,000,000.00 that member would be obligated to pay 0.01% of the claims paid by the network. This is referred to as Quota Share.

Platform 305 will automatically calculate a member's quota share on a regular basis based on claims history throughout the network, changing value of assets, and loss data. This means that if the value of an individual's personal auto depreciates then their Quota Share will decrease because the amount of the claim on a loss will be based on the Actual Cash Value of the auto Similarly, if the auto appreciates as a classic car then the Quota Share will increase for that member.

Platform 305 charges the network for maintenance and moderation. Platform 305 may institute a fee to the network based on the volume of claims paid out by the network. For example, platform 305 may charge 5% of the total value of claims paid for the month. If total claims were equal to $5,000,000.00, platform 305 may charge the network an additional $250,000.00 or 5% to maintain the network. This functions like a Claims Administration fee typically seen in the insurance world, which is as a standard is between 10-15% of premiums.

Platform 305 uses market data to save the network money. For certain classes of insurance like personal auto, the insurance rates for premiums are filed and publicly available. The platform 305 will leverage data regarding the market rate cost of insurance premiums for a particular auto to determine what an insured should be obligated to pay if they make a claim on their auto policy. For example, if the market rate for an auto is $1600.00 per year plus a $500.00 deductible. The customer has a $2100.00 repayment value for that insurance if they were to make a claim. As part of the network, the member is only obligated to pay $60 per year ($5 month) for their insurance membership. Additionally they are obligated to pay for the claims of others based on their Quota Share within the network. If this equates to $100.00 per month the member would be paying $1200.00 in premium per year instead of $1600.00. If the member makes a claim the member may be obligated by the network to pay for the difference between their actual payment ($1200.00) and the market ($2100.00) for a total of $900.00 difference.

The remaining difference may be charged to the member as additional premiums over any number of months. For example if the member is due to repay the network $900.00 they may be charged an additional $25.00 per month in premiums to bring their total to $125.00. This additional $25.00 allows the member to repay their $900.00 balance to the network in 36 months. Additionally, by charging at market rate for the insurance when a claim is made the platform 305 network reduces the likelihood that soft-fraud will occur where members make small claims and maintain their activity in the network.

Members who do not claim will continue to benefit from being members while bad risks that make claims will see little to no benefit from being part of the network. This can help adverse selection.

Platform 305 incentivizes early members to join and remain active. Platform 305 may institute a discount for early members and charge members more as they join later in the network's age. For example, the first 5,000 members of the network may over time be charged less of a Quota Share for as long as they remain active. This may be based on number of months active. If a user joins later in the network they may be charged an additional rate to join the network. If a member lapses or leaves the network they forfeit their place in line and therefore their discount. This incentive will help keep members active because returning users pay more over time than if they were to simply remain active members.

Platform 305 tracks payments into the peer network. The platform 305 may make use of a centralized or distributed database/ledge, e.g., a blockchain to contain information about each payment made by each member/peer of the network over time. This means that the system may make payments into the network publicly viewable or viewable only to other members for audit purposes. Platform 305 may make use of the payment history to calculate the ratio of payments to claims made by any member in the system and attach that or similar usage metrics to their profile. Platform 305 may also determine if a user is underpaying in relation to their long term claims and publicly make that information available for audit purposes by the entire network.

Platform 305 can handle situations when a user does not pay premiums to the network. The network for insurance coverage relies on a contract of adhesion between members. Each member is indemnified by the network against a variety of perils by others in the network (being members). This contract is aleatory in that members pay only a small amount of dues or premiums to maintain the network and pay claims for other members. This contract and the functioning of the network breaks down if platform 305 members receive coverage for any period of time and do not pay their premiums when the time arises. For example, a member may join platform 305 for $5 on January 1st. On February 1st, the member is obligated to pay $5 membership and their Quota Share of the premiums for January.

If the member does not pay, platform 305 may employ a variety of mechanisms to collect the premiums owed for January. Quota Share premiums are not for the upcoming month of coverage they are calculated in arrears. For example, platform 305 may publish a list of members who failed to meet their obligations to the network. Platform 305 may send the member's account to a traditional collections agency. Platform 305 may blacklist the member for future insurance. Platform 305 may notify other insurance carriers of the user's behavior and credit risk. Platform 305 may notify credit reporting agencies of the delinquency.

Platform 305 can handle situations when collections/payments fail. If platform 305 attempts to charge a member for their dues and the charge is declined or fails for some other reason platform 305 will notify the member that their coverage will be discontinued if the payment is not made by a certain time. For example, if payment on February 1st fails for the month the platform 305 platform will email, call, text, or push message a member to alert them that their insurance coverage will lapse in 72 hours if they do not make payment. The platform 305 will automatically notify the user as time continues toward the cancellation deadline.

Platform 305 may also use data collected from the platform 305 mobile app to determine if the user is still active (GPS updates) and determine that the user is a high likelihood of churning (cancelling) and decide to go through extra efforts to re-engage the customer.

The network can receive payment. Platform 305 is acting as the transactional network to connect members (peers) paying for claims and members making claims throughout the month. Platform 305 takes employs credit, debit, and ACH payments to collect membership dues and premiums due from members. To reimburse a claim platform 305 can use ACH/EFT payments to members. The platform 305 collects the monthly membership dues from members. This collection happens on the 1st day of each month. For example, platform 305 can charge a new member $5 for January's coverage on January 1. Platform 305 can automatically charge the member's account on this date. This can provide active coverage for the member from January 1st to January 31st. Members throughout the month of January can make claims to the platform 305 network and receive payments for their claims.

The platform 305 networks keeps an accounting log of all claims and active members during the month. On February 1st, platform 305 charges the member their $5 membership fee and any additional premiums due based on the claims made in January. The nature of claims may necessitate the need for premium charges to be billed on the 15th of each month or multiple times a month depending on the magnitude of claims, the member's history, current payment risk, and the like.

Binding online creates adverse selection because customers with potentially bad risk (poor driving history, history of claims) may prefer to purchase insurance without talking to an agent. Traditionally insurers have not desired to bind insurance through online mediums instead relying on agents. Agents serve as the first screening mechanism of an insurer's enrollment process by selecting clientele with a normal or preferred risk profile.

Platform 305 enables the risk pool to self-regulate fraudulent or bad risk users. Platform 305 may make use of algorithms/rules/machine learning to discover users that are abusing the system by committing fraud or whom are potentially ‘bad risk’ or sub-standard risk. Platform 305 may also disclose payment and claims information to the entire network via a block chain or publicly so that other users of the system may be able to determine which other users are responsible for the losses (claims) and through a voting mechanism decline those users coverage in the future to reduce the total claims exposure for the entire peer network. This can keep the operations of platform 305 a true peer-to-peer insurance network where the network decides what claims to pay and self regulates for good users over time.

Platform 305 can overcome the need for a large network (e.g., high number of members) at the outset. The network relies on a large number of members paying premiums at the end of the month to pay for claims of the others in the network. Because the number of members required to make platform 305 a cost saving option for insurance is very large, platform 305 will assume the obligations of the first N number of members. For example, if platform 305 requires 50,000 active users to distribute the risk across the network to a level in which the Quota Share of each member shows a savings for each user platform 305 may assume the obligations of the 50,000 members. If 300 members join the network, each member with only pay their 1/50,000th obligation of premiums and platform 305 will pay the 49,700/50,000th share of the premiums due. As members join the network over time, the platform's 305 obligation reduces in proportion.

Platform 305 protects against catastrophic risk. The network is designed to reduce premiums for members for risks and claims encountered in normal cycles. If a natural disaster were to strike a large number of insured for a high claims amount, the network may not be able to support all the claims through the payments of the members. For circumstances such as these, platform 305 purchases catastrophic insurance. The cost of this insurance may be paid by platform 305 on behalf of the members or includes as part of their premium payments. As the network grows the amount of catastrophic risk coverage increases and platform 305 will need to pay premiums monthly.

Platform 305 balances concentration risk in real time. In the circumstance that platform 305 becomes a popular form of insurance in one particular locale it may be necessary for platform 305 to distribute concentration risk around the network in real time. For example, if a high number of members from Santa Monica, Calif. join and purchase Homeowner's Insurance from Sure. The network may determine through calculation/algorithms/actuarial tables that the networks has too much risk exposure to Homeowners in Santa Monica, Calif. The system may then automatically prevent new users in Santa Monica from joining until other Homeowner's Insurance members join in a different locale to distribute the risk. For example, a new user in Santa Monica may need to wait until another member joins platform 305 for Homeowner's Insurance in Stockholm. This means that the network is geographically diverse enough to handle risks. This system does not require underwriters, it is managed in real time by the platform.

Platform 305 uses automatic penalties/handicaps to reduce payment lapse. Platform 305 relies on the majority of the network paying premiums and membership to ensure the integrity of the system and claims. If a member fails to pay their membership or their premiums in time before lapse, the system may prevent the member from joining the network again or the system may place a penalty on the user to discourage this type of behavior. For example, if the user wishes to rejoin after a lapse, the member may need to receive approval from others in the network (the peers) to reach a consensus of whether or not the user should be reinstated with insurance.

Additionally, the system may charge the user a higher Quota Share for a period of time until their trust in the network is regained. For example, if a member lapses and rejoins they will be required to pay their $5 membership fee for the month of coverage, however the member may be forced to pay a 10% additional amount on their monthly premium for 3 months. For example, Quota Share of a normal user is equal to their 100% obligation. A returning user may need to pay 110% to demonstrate to the network that they are willing to participate in the network and not lapse.

Members who lapse or leave the network do not have their profile data removed from the network. The identity remains for the other peers to view and analyze even if the member is no longer active. This is part of the ledger that is ongoing from the outset of the network.

Platform 305 incentivizes members to provide digital or physical receipts. Insurers typically ask for proof of ownership when an insured claims for lost or damaged property. This creates a point of friction for insureds because they need to have accurate records of all purchases going back historically. The platform 305 can provide users with expedited claims payment for items that have already been included in the insured's property by way of showing a receipt. Platform 305 can leverage data from the member's payment methods (debit or credit card) or bank account data to analyze purchases and automatically enter them into the member's insured property ledger.

Platform 305 can also track receipts received by the insured via email either by allowing the member to forward email receipts to a specific email address for parsing or by connecting their email account to their platform 305 platform account. Platform 305 can also allow members to take a picture of their physical paper receipts using the platform 305 mobile application. These receipts can be digitally stored and analyzed to extract relevant purchase data for the claim. For members of the network who have either provided receipts manually at the time of purchase or optioned to connect their accounts to the platform 305 platform they are eligible to receive faster claims and payment process for claims because the data was provided prior to the claim and aids in risk assessment.

Platform 305 uses first-degree social connections to improve the network. For the network to function at its optimal savings for all members, the network should be filled with standard or better than standard preferred risk. The nature of an open network of peers is such that members are able to join without an agent or analyst first speaking with the member. The platform 305 uses automatic rules and algorithms to encourage existing members to invite only connections that are good risk.

The network may employ a wait list to join or impose certain requirements before allowing members who did not receive an invite from joining. For example, members who were not invited and simply join the platform 305 network without any other connections to existing members may need to provide additional validation steps to become active.

Members who have been invited by existing users may need to provide less information or become active sooner because assumptions of risk can be placed on them based on the member that invited them. This principle is based on the concept that a person is most like the five people they are closest to/spend the most time with—so if a person's connections are bad insurance risk, there is a higher probability that you too will be bad risk.

The platform 305 encourages members to invite their connections to the network based on the idea that the more members included in the network the less each member pays with one caveat that each new member does not claim above the mean claims rate of the existing network. The ongoing goal should be add new members who make fewer claims than the current average and then the quality of the network increases over time.

Platform 305 may incentivize each member for inviting new users with a reward at the outset. However, platform 305 provides two other mechanisms to encourage only good invitations to new members being extended. First, if an existing member invites five new members who prove to be good risk over their first six months of membership the network may reduce the amount of premium (Quota Share) the inviting member is obligated to pay for a time. Therefore, the better people a member invites the less they pay for insurance. Second, if an existing invites members who are substantially more costly to the network than the average member the inviting member may be penalized by the network and be forced to pay more than their Quota Share of premiums. This is to discourage inviting members who are bad risk. This in essence creates a sub-group within the larger network that is constantly compared to the overall group on a variety of factors. The sub-group rating can result in additional charges (surged pricing) or savings (10% discount). The platform may or may not expose to the user that they're being charged a different rate.

Platform 305 handles primary property different from secondary property. The platform 305 and peer-to-peer network makes use of data from smartphones and other sources to allow for better risk underwriting. One source comes from the primary insured's behavior and the data collected. This may mean that platform 305 only provides insurance for the insured's primary used property. For example, platform 305 can determine the primary residence and other behaviors of the insured, however platform 305 has less of a data advantage to arbitrage when insuring the second home of an insured or a second car. Platform 305 may then determine what property to insured over time and use the platform's score of the member's risk over time determine if the peer network will insure the secondary property. Sure may also ask the peer network to vote to approve any property entering the pool.

Platform 305 uses identity to prevent fraud. The platform 305 network leverages technology, networks, and crowds to incent users to not commit fraud and leverages the network to catch fraudulent users.

Platform 305 uses technology to prevent the following situation: (1) a user joins a network via platform 305 for $5 a month (Or other nominal membership fee); (2) The user submits a claim for several thousand dollars within a short period after joining; (3) the user then should be obligated to remain in the network for a long period of time paying out the claims of other users, however this user receives payment for their claim (fraudulent or legitimate) and then leaves the network never having paid for a single claim. This gaming of the system is solved through technology.

Platform 305 uses other platforms to reduce fraud. In traditional online platforms customers can create multiple accounts using multiple email addresses or Facebook profiles to game the system to their advantage. Platform 305 makes use of multiple high value data sources which may have already done true-identity validation to reduce the likelihood that a single user, potentially one who has already been banned for any reason, from joining again. For example, the member would have their identity verified, their bank account, their gmail, their phone number, their social media, and more validated. Any one of these items can possibly be circumvented with alternate source, however by creating new or fraudulent accounts for each data source the platform 305 platform will be able to determine a normal user's behavior vs that of a fraudulent user. This prevents a single user from defrauding the network repeatedly.

Platform 305 includes a claim validation process. Platform 305 may make use of a variety of mechanisms for validating a claim from a user. For example, platform 305 may use a traditional adjustment model where if a claim is made on a home or auto that platform 305 dispatches a claims adjuster to determine the loss for the insured. For example, platform 305 may ask the insured suffering the loss to submit photos, videos, or audio documenting the loss through the platform 305 (e.g., using an application on their mobile device) or other digital medium. For example, platform 305 may make use of the humans (Amazon Mechanical Turk) to see anonymized or non-anonymized details of the insured's claim and vote if the claim should be paid. The humans participating may be 3rd party or they may be members of the platform 305/peers of the insured.

Platform 305 may validate the legitimacy of the claim with other payers in the system and make use of 1 or more votes to determine the score and approve the claim if a certain threshold is reached or escalate the claim for further review if not approved by the network. Platform 305 also makes users initiating a claim digitally sign that they understand the laws about insurance fraud before beginning the claims process.

Platform 305 may build a graph/network around an individual insured to determine what other users of the pool/network have a real life connection to that user. Platform 305 may then ask these users with a 1-degree separation from the insured to also sign and attest that the claim is valid. Platform 305 may then use these votes to determine over time which users are likely to approve claims for others that are potentially fraudulent to give them a score for the system to use when processing a their claim in the future. In short, if users are willing to commit fraud for other users then they are likely willing to commit fraud themselves. This information can be collected over time and as fraud is discovered within the network using machine learning and algorithms being updated by humans.

Platform 305 may use time to de-risk claims for the network. Platform 305 may structure the coverage for a user in a variety of ways to ensure that new members cannot charge a claim to the network before their worthiness has been determined. For example, platform 305 may use a ramp-up/growing coverage mechanism to increase a member's coverage each month that they continue to pay their membership dues. Platform 305 may only pay 3% of the claim made by a member in the first month of membership escalating at an additional 2% per month. In 24 months, the network will pay 100% of the claim made by the user.

The rate at which a member's claims will reach 100% may be accelerated by a variety of factors. For example, providing additional identity validation steps, inviting more members to the network, assisting in claims or other work needed by the network, and the like. The payment history of a member (over 24 months for example) is a large indicator of their commitment to the network. Additionally, platform 305 may accelerate the time to 100% coverage based on the number of claims a member makes. For example, if a member makes zero claims in the first 12 months they may automatically achieve the 100% coverage.

Platform 305 uses data to validate claims. The Peer-to-Peer network enables members to receive low cost or $0 insurance coverage for all types of insurance. In order to support the network platform 305 must leverage data to ensure that fraud prevention is as accurate as possible.

Platform 305 makes use of data during the claims process to detect fraudulent activity. During the claims process members may be instructed to provide access to their email, text messages, social media, banking, or other smartphone apps before receiving their payment. Platform 305 uses the forensic data provided by these any other sources to determine if the story provided by the member about the cause of their loss is plausible. For example, if a member claims that their house was damaged by an overflowing toilet while they were away on holiday platform 305 can determine if the member was staying at the house the night of the water damage or if they had rented the house to an AirBnb guest who, while the owners were out of town, caused the loss. This can be found by looking at the member's email history and other data sources.

This regression analysis is conducted by humans with the aid of algorithms and heuristics. As fraudulent claims are profiled, they are used to improve the algorithms so that the platform can automatically detect fraudulent claims and platform 305 can expand their data sources accordingly.

The platform 305 uses close (first degree) connections to validate claims. Once a member has one or more first degree connections as members in the network the network and platform may leverage these connections to validate a claim made by the member. By using connections close to a member making a claim the platform can reduce the need for an independent adjuster to validate claims. For example, if a member claims theft of a $10,000 Rolex watch the system will automatically contact any number of connections to the claimant and ask them to validate the claim.

The validation could include having the connections sign that they agree to not commit insurance fraud. Then by asking questions such as did they know the member owned a variety of property (Rolex Watch, Jetski, Golf Clubs, and the like) this is used to validate how well the connection knows the member. Then the system may ask if the watch they owned was stolen. The platform 305 will alert the member that if fraud is discovered and they lied about the claim on behalf of the other member that they risk being penalized and charged more for their insurance, blacklisted from the network, reported to other insurers, and made part of any legal proceedings. The platform 305 can do all of this automatically and check for validity of responses by checking the location of the user, their IP address, how quickly the questions were answered, and the like.

The data is valuable to prove to the others in the network that a claim is valid. The penalties can also be applied at any time in the future if an older claim is discovered to have been fraudulent. Any time a first degree connection validates a claim this information may be made public to the network so that other peers can see who validated a claim. These allow the network to determine if certain members do not actively validate claims or assist in fraud.

Platform 305 can use remote adjusters to validate claims. Platform 305 may make use of an application on mobile devices to enable a member to do a remotely guided review of the damage done to their property. This video and audio log may be reviewed in real time or recorded to the platform 305 for review at a later time. This review may be watched by one or more people, either employed by platform 305 or part of the peer network as part of the claims approval process.

The platform 305 peer-to-peer platform publishes data about each claim for other peers to view. If a member makes low value claims the network will most likely approve the claims, however the frequency of claim is viewable by others and factors into the ranking and risk metrics determined by the platform. After a certain number of claims a user may be removed from the network, either automatically by algorithm, or by platform 305 employees or members of the peer network.

The subject matter described herein provides many technical advantages. For example, customers can now purchase insurance without the need for brokers and agents. Additionally, by offering them insurance the moment they make the purchase the customer has less of a chance of being uninsured or having gaps in coverage between the time they purchase the article and when they could insure through other means without the platform pushing them an offer.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A method for implementation by at least one data processor forming part of at least one computing system, the method comprising:
receiving, by the at least one data processor, data characterizing claim information submitted for approval by a member of a peer-to-peer risk pool;
inserting, using the at least one data processor, the claim information as a transaction into a block using a private key;
adding, using the at least one data processor, the block to a chain of blocks, the chain of blocks including prior claim and payment information of the member; and
distributing, using the at least one data processor, the chain of blocks to a plurality of additional members of the peer-to-peer risk pool for review by the additional members for approving or disproving the claim.

2. The method of claim 1, wherein the claim information includes location of the claim, amount of loss defined by the claim, and cause of loss.

3. The method of claim 1, wherein the claim information includes name of the member who started the claim, the claim to payment ratio into the peer network of the member, and the member's claims history throughout time.

4. The method of claim 1, wherein prior claim information includes historical claim information of the member submitting the claim.

5. The method of claim 1, wherein the payment information includes records describing a payment record of the member submitting the claim.

6. A method for implementation by one or more data processors forming part of at least one computing system, the method comprising:
accessing, using the at least one data processor, data characterizing real-time behavior and historical behavior of an individual;
computing, using the real-time behavior and the historical behavior, a targeted insurance policy that includes a policy type and one or more policy terms, the policy type defining a type of loss the policy insures against;
determining a targeted advertisement characterizing the policy type and one or more policy terms;
determining when to modify an advertisement display space of a graphical user interface of a mobile device associated with the individual, the determining based on the real-time behavior and historical behavior of the individual; and
modifying the advertisement display space to include the targeted advertisement, the targeted advertisement prompting the individual to enter into the targeted insurance policy.

7. The method of claim 6, wherein the targeted advertisement includes a graphical object that, when selected by the individual, causes the individual to be bound to the targeted insurance policy.

8. The method of claim 7, wherein the advertisement display space is a third party system and a selection of the graphical object in the targeted advertisement by the individual causes the individual to be bound to the targeted insurance policy via the third party system.

9. The method of claim 6, wherein the determining when to modify the advertisement display space includes computing a relevant time using a machine learning algorithm analyzing historical behavior data for the user and a plurality of additional users.

10. The method of claim 6, wherein computing the targeted insurance policy includes determining the policy type and one or more policy terms using a profile of the user characterizing risk associated with the user.

11. The method of claim 6, wherein the data characterizing real-time behavior is received from the mobile device associated with the individual.

12. The method of claim 6, wherein the data characterizing real-time behavior includes one or more measurements from a sensor of the mobile device, the data including one or more of accelerometer data, sound data, humidity data, and location data.

13. The method of claim 6, wherein real-time behavior or historical behavior is determined by performing a geo-fencing analysis of location data of the mobile device.

14. The method of claim 6, wherein real-time behavior or historical behavior is acquired by accessing an email account of the individual and parsing emails.

15. The method of claim 6, wherein real-time behavior or historical behavior is acquired by accessing a social network account or e-commerce account of the individual.

16. A system comprising:
at least one data processor;
memory storing instructions which, when executed by the at least one data processor, causes the at least one data processor to perform operations comprising:
receiving, by the at least one data processor, data characterizing claim information submitted for approval by a member of a peer-to-peer risk pool;
inserting, using the at least one data processor, the claim information as a transaction into a block using a private key;
adding, using the at least one data processor, the block to a chain of blocks, the chain of blocks including prior claim and payment information of the member; and
distributing, using the at least one data processor, the chain of blocks to a plurality of additional members of the peer-to-peer risk pool for review by the additional members for approving or disproving the claim.

17. The system of claim 16, wherein the claim information includes location of the claim, amount of loss defined by the claim, and cause of loss.

18. The system of claim 16, wherein the claim information includes name of the member who started the claim, the claim to payment ratio into the peer network of the member, and the member's claims history throughout time.

19. The system of claim 16, wherein prior claim information includes historical claim information of the member submitting the claim.

20. The system of claim 16, wherein the payment information includes records describing a payment record of the member submitting the claim.
